(19) United States
(12) Patent Application Publication
(10) Pub. No.: US 2018/0107300 A1
(43) Pub. Date: Apr. 19, 2018

(54) TOUCH DISPLAY PANEL AND SENSING AND DRIVING METHOD THEREOF

(71) Applicant: AU Optronics Corporation, Hsin-Chu (TW)

(72) Inventors: Cheng-Hsing LIN, Hsin-Chu (TW); Wei-Hung Kuo, Hsin-Chu (TW)

(21) Appl. No.: 15/725,451

(22) Filed: Oct. 5, 2017

(30) Foreign Application Priority Data
Oct. 18, 2016 (TW) 105133516

(51) Int. Cl. G06F 3/044; G02F 1/1335; G02F 1/1333; G02F 1/1343; G06F 3/041

(52) U.S. Cl. CPC G06F 3/044; G02F 1/133514; G02F 1/13338; G06F 3/0416; G06F 3/0412; G06F 3/0414; G02F 1/134336

(57) ABSTRACT

A touch display panel and a driving method thereof are provided. The touch display panel has a first electrode layer, a second electrode layer, a third electrode layer, a first dielectric layer, a second dielectric layer and an active layer. The first electrode layer is positioned between the first electrode layer and the second electrode layer. The second dielectric layer has a flexible material. The touch display panel performs touching point detection via the first electrode layer and the second electrode layer and performs touching force detection via the second electrode layer and the third electrode layer. Within durations without performing the touching force detection, a common voltage for driving pixels of the touch display panel is provided to the third electrode layer.

### BACKGROUND

### Technical Field

The present disclosure relates to a touch display panel and a sensing and driving method thereof, and in particular, to a touch display panel with functions of detecting a touch position and detecting a touch pressure and a sensing and driving method thereof.

### Related Art

Owing to a touch panel is integrated with a liquid crystal display (LCD), cost can be lowered, and thickness of a touch display apparatus is therefore reduced. However, a touch sensor of the touch panel integrated with the LCD can only detect a touch position but not detect a magnitude of a touch pressure. If a function of detecting a touch pressure is needed, an external pressure sensor (for example: a force sensor) is needed to execute the function. However, using the external pressure sensor not only leads to more adhesive procedures, but the extra thickness of the external pressure sensor increases the thickness of the touch display apparatus, which violates a current tendency of thinning, and the external pressure sensor may also cause optical quality of the LCD to deteriorate.

### SUMMARY

An embodiment of the present disclosure provides a touch display panel. The touch display panel includes a first electrode layer, a second electrode layer, a third electrode layer, a first dielectric layer, a second dielectric layer, and an active layer. The first electrode layer includes a plurality of first sensing electrodes, the second electrode layer includes a plurality of second sensing electrodes, the third electrode layer includes a plurality of third sensing electrodes, the first dielectric layer is disposed between the first electrode layer and the second electrode layer, and the second dielectric layer includes a flexible material. The active layer is configured to determine a touch position of the touch display panel according to a capacitance variation between the first sensing electrodes and the second sensing electrodes; in a first interval, determine a touch pressure at the touch position according to a capacitance variation between the second sensing electrodes and the third sensing electrodes; and in a second interval, provide a common voltage to the third sensing electrodes. The first interval and the second interval do not overlap each other in time sequence, and the common voltage has a constant voltage level provided for the touch display panel to execute pixel driving.

An embodiment of the present disclosure provides a touch display panel. The touch display panel includes a first electrode layer, a second electrode layer, a first dielectric layer, and an active layer. The first electrode layer includes a plurality of first sensing electrodes, and the second electrode layer includes a plurality of second sensing electrodes. The first dielectric layer is formed between the first electrode layer and the second electrode layer and includes a flexible material. The second electrode layer is formed over the active layer. The active layer is configured to in a first interval, determine a touch position of the touch display panel according to a capacitance variation between the first sensing electrodes and the second sensing electrodes; in a second interval, determine a touch pressure at the touch position at least by means of the second sensing electrodes; and in a third interval, provide a common voltage to the second sensing electrodes. The first interval, the second interval, and the third interval do not overlap each other in time sequence, and the common voltage has a constant voltage level provided for the touch display panel to execute pixel driving.

An embodiment of the present disclosure provides a sensing and driving method for driving a touch display panel. The touch display panel includes a first electrode layer, a second electrode layer, a third electrode layer, a first dielectric layer, and a second dielectric layer. The first electrode layer includes a plurality of first sensing electrodes, the second electrode layer includes a plurality of second sensing electrodes, the third electrode layer includes a plurality of third sensing electrodes, the first dielectric layer is disposed between the first electrode layer and the second electrode layer, and the second dielectric layer includes a flexible material. The sensing and driving method includes: providing a first driving signal to the second sensing electrodes for the touch display panel to detect a touch position; receiving a first sensing signal from the first sensing electrodes to detect a touch position of the touch display panel, where a voltage level of the first sensing signal is related to a capacitance variation between the first sensing electrodes and the second sensing electrodes; in a first interval, receiving a second sensing signal, so as to determine the touch pressure at the touch position; and in a second interval, providing a common voltage to the third sensing electrodes. The first interval and the second interval do not overlap each other in time sequence, and the common voltage has a constant voltage level provided for the touch display panel to execute pixel driving.

An embodiment of the present disclosure provides a sensing and driving method for driving a touch display panel. The touch display panel includes a first electrode layer, a second electrode layer, and a first dielectric layer. The first electrode layer includes a plurality of first sensing electrodes, and the second electrode layer includes a plurality of second sensing electrodes. The first dielectric layer is formed between the first electrode layer and the second electrode layer and includes a flexible material. The sensing and driving method includes: in a first interval, providing a first driving signal to the second sensing electrodes, and receiving a first sensing signal from the first electrode layer, so as to detect a touch position of the touch display panel, where a voltage level of the first sensing signal is related to a capacitance variation between the first sensing electrodes and the second sensing electrodes; in a second interval, receiving a second sensing signal from the second sensing electrodes, so as to determine a touch pressure at the touch position; and in a third interval, providing a common voltage to the second sensing electrodes. The first interval, the second interval, and the third interval do not overlap each other in time sequence, and the common voltage has a constant voltage level provided for the touch display panel to execute pixel driving.

An embodiment of the present disclosure provides a sensing and driving method for driving the touch display panel. The sensing and driving method includes: providing a first driving signal to the second sensing electrodes, and receiving a first sensing signal from the first sensing electrodes, so as to detect a touch intensity of a touch event of the touch display panel according to a position detection frequency; judging whether the touch intensity of the touch event is greater than a first touch intensity; when the touch intensity of the touch event is greater than the first touch intensity, detecting the touch pressure according to a pressure detection frequency, and detecting the touch event according to the position detection frequency, where the pressure detection frequency is less than the position detection frequency; judging whether the touch pressure is greater than a preset pressure; and when the touch pressure is greater than the preset pressure, adjusting the position detection frequency or the pressure detection frequency to make the pressure detection frequency greater than the position detection frequency.

In each embodiment of the present disclosure, a time-multiplexing manner is used, in different intervals, a plurality of sensing electrodes of one of the electrode layers as electrodes for detecting a magnitude of a touch control force borne at a touch position and as common electrodes for providing a common voltage in a time-multiplexing manner. Therefore, one and the same electrode layer may have double functions, so that the overall thickness of a touch display panel can be effectively reduced, which is beneficial to thinning the touch display panel. In addition, because one and the same electrode layer may have the foregoing double functions, the touch display panel can be provided with a function of detecting a magnitude of an external force without using an external pressure sensor, which can relatively reduce adhering procedures.

### BRIEF DESCRIPTION OF THE DRAWINGS

FIG. 1 is a stacking diagram of a touch display panel including three electrode layers according to an embodiment of the present disclosure;

FIG. 2 is a structural diagram of the three electrode layers of the touch display panel of FIG. 1;

FIG. 3 is a stacking diagram of a touch display panel including three electrode layers according to a first embodiment of the present disclosure;

FIG. 4 is a stacking diagram of a touch display panel including three electrode layers according to a second embodiment of the present disclosure;

FIG. 5 is a stacking diagram of a touch display panel including three electrode layers according to a third embodiment of the present disclosure;

FIG. 6 illustrates a relevant signal of a touch display panel according to an embodiment of the present disclosure;

FIG. 7 illustrates a sensing and driving method according to an embodiment of the present disclosure;

FIG. 8 illustrates a relevant signal of a touch display panel according to another embodiment of the present disclosure;

FIG. 9 illustrates a sensing and driving method according to another embodiment of the present disclosure;

FIG. 10 is a stacking diagram of a touch display panel including three electrode layers according to a fourth embodiment of the present disclosure;

FIG. 11 is a stacking diagram of a touch display panel including three electrode layers according to a fifth embodiment of the present disclosure;

FIG. 12 is a structural diagram of three electrode layers of a touch display panel according to an embodiment of the present disclosure;

FIG. 13 illustrates a relevant signal of a touch display panel according to an embodiment of the present disclosure;

FIG. 14 illustrates a sensing and driving method according to an embodiment of the present disclosure;

FIG. 15 is a stacking diagram of a touch display panel including two electrode layers according to an embodiment of the present disclosure;

FIG. 16 is a structural diagram of the two electrode layers of the touch display panel of FIG. 15;

FIG. 17 is a stacking diagram of a touch display panel including two electrode layers according to a sixth embodiment of the present disclosure;

FIG. 18 is a stacking diagram of a touch display panel including two electrode layers according to a seventh embodiment of the present disclosure;

FIG. 19 illustrates a relevant signal of a touch display panel according to an embodiment of the present disclosure;

FIG. 20 illustrates a sensing and driving method according to an embodiment of the present disclosure;

FIG. 21 is a stacking diagram of a touch display panel including two electrode layers according to an eighth embodiment of the present disclosure;

FIG. 22 is a structural diagram of the two electrode layers of the touch display panel of FIG. 21;

FIG. 23 illustrates a relevant signal of a touch display panel according to an embodiment of the present disclosure;

FIG. 24 illustrates a sensing and driving method according to an embodiment of the present disclosure;

FIG. 25 is a sequence diagram of a relevant signal of a touch display panel according to an embodiment of the present disclosure;

FIG. 26 is a sequence diagram of a relevant signal of a touch display panel according to another embodiment of the present disclosure;

FIG. 27 is a sequence diagram of a relevant signal of a touch display panel according to another embodiment of the present disclosure;

FIG. 28 is a flowchart of a sensing and driving method according to an embodiment of the present disclosure;

FIG. 29 is a flowchart of a sensing and driving method according to another embodiment of the present disclosure;

FIG. 30 is a flowchart of a sensing and driving method according to still another embodiment of the present disclosure.

### DETAILED DESCRIPTION

Generally, a touch control-type LCD panel may include an upper substrate, a color filter, a liquid crystal layer, an active layer, and a lower substrate in sequence from the top to the bottom, and a touch display panel disclosed by the present disclosure integrates some or all electrode layers for detecting a touch position and detecting a touch pressure in the touch display panel, so as to reduce the thickness of the touch display panel and integrate touch control display functions. A touch display panel of each embodiment of the present disclosure may be a touch control-type LCD panel. In addition, the active layer is a driving component layer of a display area of the touch display panel and may include a metal layer such as a data line or a scan line. Specific implementation manners of a touch display panel of the present disclosure and a sensing and driving method thereof are described in detail below.

Referring to FIG. 1, FIG. 1 is a stacking diagram of a touch display panel 100 including three electrode layers according to an embodiment of the present disclosure. The touch display panel 100 includes three electrode layers, which are respectively an electrode layer 120, an electrode layer 140, and an electrode layer 160, and as shown in FIG. 1, the touch display panel 100 includes an upper substrate 110, the electrode layer 120, a dielectric layer 130, the electrode layer 140, a dielectric layer 150, the electrode layer 160, an active layer 170, and a lower substrate 180 in sequence from the top to the bottom. The dielectric layer 130 is sandwiched between the electrode layer 120 and the electrode layer 140. The dielectric layer 150 is disposed between the electrode layer 140 and the electrode layer 160 and includes a flexible material, so as to be deformable under a pressure. The electrode layer 120, electrode layer 140, and electrode layer 160 may be a transparent electrode (ITO) or of another transparent conductive material. The active layer 170 is a driving component layer of a display area of the touch display panel 100 and may include a metal layer such as a data line or a scan line.

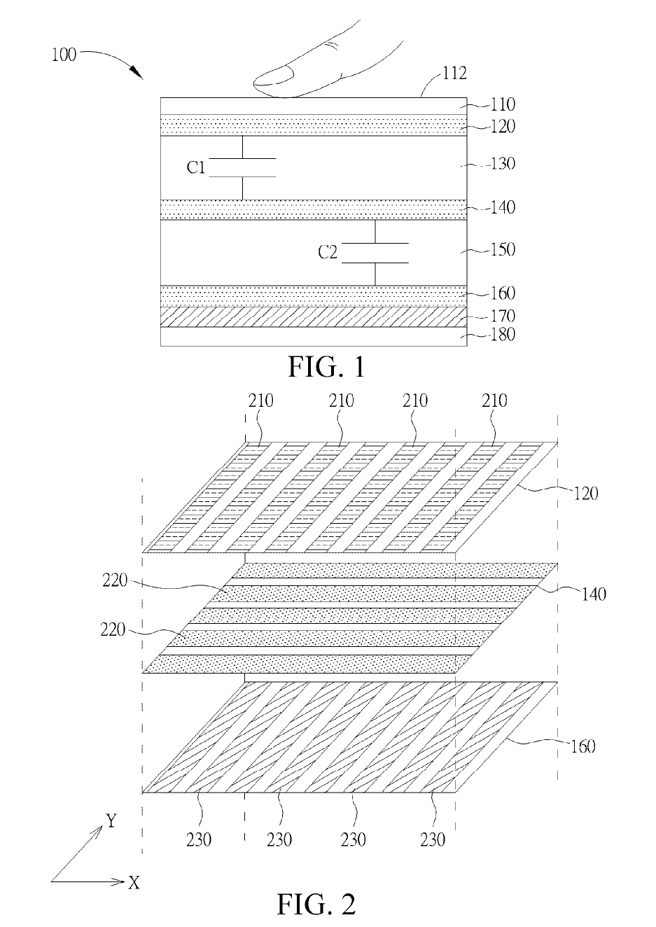

Referring to FIG. 2, FIG. 2 is a structural diagram of the electrode layer 120, electrode layer 140, and electrode layer 160 of the touch display panel 100 including three electrode layers of FIG. 1. The electrode layer 120 includes a plurality of sensing electrodes 210 disposed in parallel along a Y direction, the electrode layer 140 includes a plurality of sensing electrodes 220 disposed in parallel along an X direction, and the electrode layer 160 includes a plurality of sensing electrodes 230 disposed in parallel along the Y direction, where the X direction and the Y direction have a non-zero included angle on an XY plane thereof. In this embodiment, the included angle between the X direction and the Y direction on the XY plane thereof equals 90 degrees, but the present disclosure is not limited thereto, and the included angle between the X direction and the Y direction on the XY plane thereof may equal another angular degree. In addition, although the sensing electrodes 210 and the sensing electrodes 23 are all disposed in parallel along the Y direction, in other embodiments of the present disclosure, the sensing electrodes 210 and the sensing electrodes 230 may be disposed along different directions, and a direction for disposing the sensing electrodes 210 and a direction for disposing the sensing electrodes 230 are not parallel to a direction for disposing the sensing electrodes 220.

A sensing and driving manner of the touch display panel 100 is described in the following. Refer to FIG. 1 to FIG. 2 again. When the touch display panel 100 inputs a signal, the sensing electrodes 210 of the electrode layer 120 and the sensing electrodes 220 of the electrode layer 140 generate an electrical field, which has a capacitance variation C1, because the dielectric layer 130 is sandwiched therebetween, and the sensing electrodes 220 of the electrode layer 140 and the sensing electrodes 230 of the electrode layer 160 generate a capacitance variation C2, because the dielectric layer 150 is sandwiched therebetween. When a user touches a touch control surface 112 of the touch display panel 100 with a finger or a stylus, so as to cause the capacitance variation C1 to change between the electrical field between the electrode layer 120 and the electrode layer 140 changes, the touch display panel 100 can determine a touch event and a touch position according to the change of the capacitance variation C1. In addition, the dielectric layer 150 may include a flexible material, when the touch control surface 112 is subject to a pressure and causes the dielectric layer 150 to deform, the capacitance variation C2 of the dielectric layer 150 is changed, and the touch display panel 100 can determine a magnitude of the touch pressure at the touch position according to the change of the capacitance variation C2. It is worth noting that the electrode layer 140 is disposed between the electrode layer 120 and the electrode layer 160 and may serve as a transmitting end of a driving signal for detecting a touch position and serve as a transmitting end of a driving signal for detecting a touch pressure, and in the present disclosure, the electrode layer 140 serves as transmitting ends of driving electrodes for detecting a touch position and detecting a touch pressure in a sharing manner. Moreover, the electrode layer 160 may be a common electrode layer used by the touch display panel 100 for providing a common voltage VCOM to execute a display function, and the common voltage VCOM has a constant voltage level provided for the touch display panel 100 to execute pixel driving. The touch display panel 100 provides the common voltage VCOM and receives a sensing signal in a time-multiplexing manner by sharing the electrode layer 160, so as to detect a touch position and detect a touch pressure, so that the thickness of the touch display panel 100 can be effectively reduced.

### First Embodiment

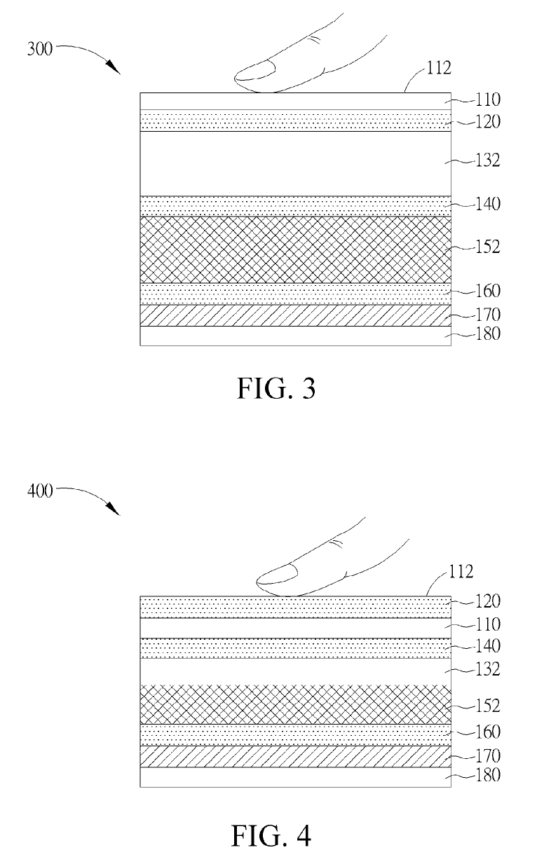

Referring to FIG. 3, FIG. 3 is a stacking diagram of a touch display panel 300 including an electrode layer 120, an electrode layer 140, and an electrode layer 160 according to a first embodiment of the present disclosure. The touch display panel 300 may be applied to an In Plane Switching (IPS) display panel and the like, whose common electrode layer is immediately adjacent to an active layer. The touch display panel 300 includes an upper substrate 110, the electrode layer 120, a dielectric layer 130, the electrode layer 140, a dielectric layer 150, the electrode layer 160, an active layer 170, and a lower substrate 180 in sequence from the top to the bottom. The dielectric layer 130 may be a color filter layer 132, and the dielectric layer 150 may be a liquid crystal layer 152. A structure of the three electrode layers 120, 140, and 160 of the touch display panel 300 may be as stated above (as shown in FIG. 2). In addition, the touch display panel 300 may also include an upper polarizer and a lower polarizer (not shown) disposed on an outer side of the touch display panel 300.

### Second Embodiment

Referring to FIG. 4, FIG. 4 is a stacking diagram of a touch display panel 400 including three electrode layers 120, 140, and 160 according to a second embodiment of the present disclosure. The touch display panel 400 includes the electrode layer 120, a dielectric layer 130, the electrode layer 140, a dielectric layer 150, the electrode layer 160, an active layer 170, and a substrate 180 in sequence from the top to the bottom. The dielectric layer 130 is an upper substrate 110, sandwiched between the electrode layer 120 and the electrode layer 140. The dielectric layer 150 may include a color filter layer 132 and a liquid crystal layer 152 and is sandwiched between the electrode layer 140 and the electrode layer 160. In addition, a structure of the three electrode layers 120, 140, and 160 of the touch display panel 300 may be as stated above (as shown in FIG. 2).

### Third Embodiment

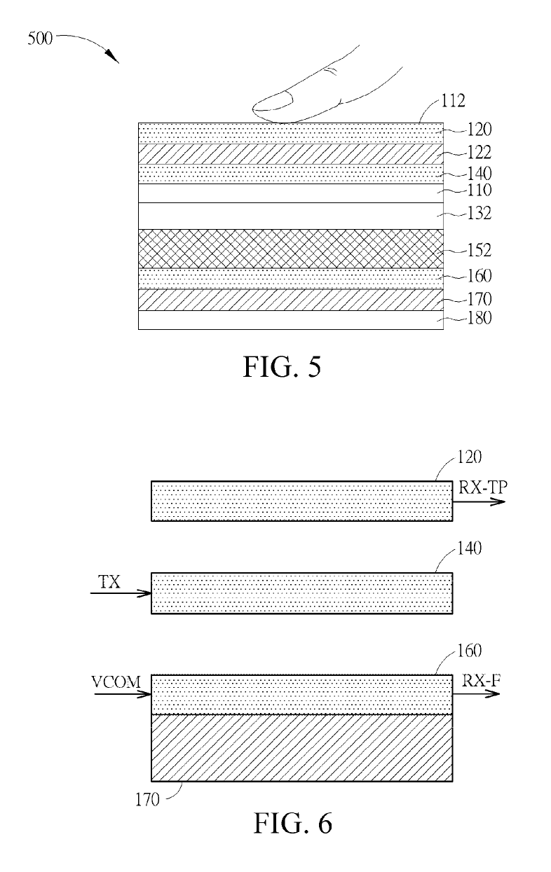

Referring to FIG. 5, FIG. 5 is a stacking diagram of a touch display panel 500 including three electrode layers 120, 140, and 160 according to a third embodiment of the present disclosure. The touch display panel 500 may be applied to an In Plane Switching (IPS) display panel and the like, whose common electrode layer is adjacent to an active layer. The touch display panel 500 includes the electrode layer 120, a dielectric layer 130, the electrode layer 140, a dielectric layer 150, the electrode layer 160, an active layer 170, and a lower substrate 180 in sequence from the top to the bottom. The dielectric layer 130 may be an insulating layer (insulator) 122, and the dielectric layer 150 may be an upper substrate 110, a color filter layer 132, and a liquid crystal layer 152. In addition, a structure of the three electrode layers 120, 140, and 160 of the touch display panel 300 may be as described in FIG. 2.

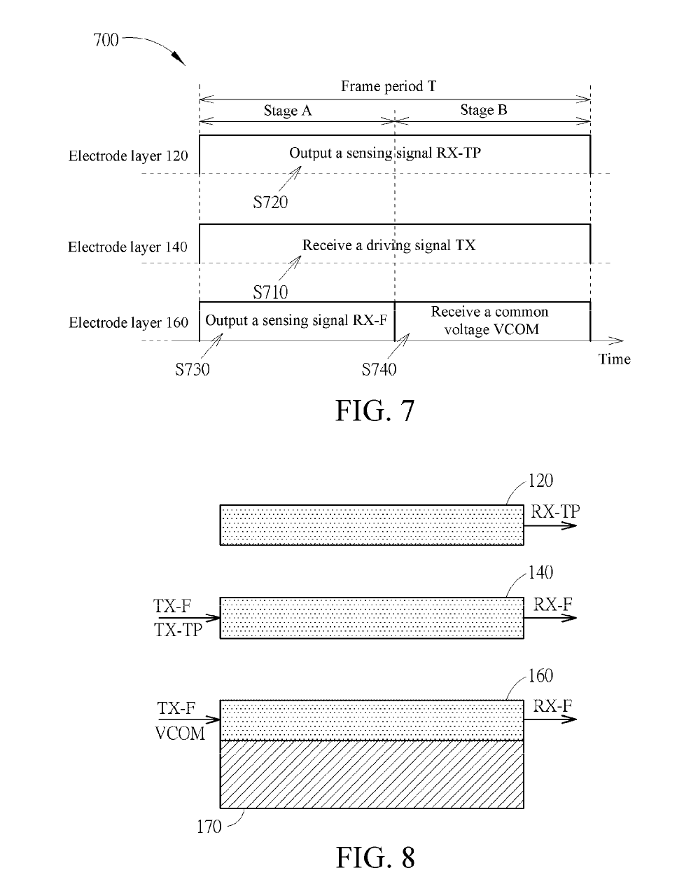

Detailed acting manners of the touch display panels 100, 300, 400, and 500 including the three electrode layers 120, 140, and 160 are described in the following. Referring to FIG. 6 and FIG. 7, FIG. 6 illustrates a relevant signal of a touch display panel (the touch display panels 100, 300, 400, and 500 as stated above) according to an embodiment of the present disclosure, and FIG. 7 illustrates a sensing and driving method 700 according to an embodiment of the present disclosure, which is applicable to a touch display panel having an architecture of three layers of sensing electrodes (the touch display panels 100, 300, 400, and 500 as stated above). The sensing and driving method 700 includes:

Step S710: An electrode layer 140 receives a driving signal TX from a control unit (not shown), that is, the control unit provides the driving signal TX to the electrode layer 140, where the control unit may be an integrated circuit (IC) or a driving circuit to receive a sensing signal or provide a driving signal to a touch display panel, and may, for example, be a touch control driving circuit, a display driving circuit, a data driving circuit, a sequence control unit, or the like, and the present disclosure is not limited thereto.

Step S720: An electrode layer 120 outputs a sensing signal RX-TP to the control unit (that is, the control unit receives the sensing signal RX-TP from the electrode layer 120), so as to detect a touch position.

Step S720: In a interval A, an electrode layer 160 outputs a sensing signal RX-F to the control unit (that is, the control unit receives the sensing signal RX-F from the electrode layer 160), so as to detect a magnitude of a touch pressure at the touch position.

Step S740: In a interval B, the electrode layer 160 receives a common voltage VCOM provided by the control unit. The interval A and the interval B do not overlap each other in time sequence, and the common voltage VCOM has a constant voltage level provided for the touch display panel to execute pixel driving.

In this embodiment, steps S710 to S740 may be executed once in each frame period T of the touch display panels 100, 300, 400, and 500, that is, the touch display panels 100, 300, 400, and 500 periodically execute steps S710 to S740. Each frame period T includes a interval A and a interval B, the interval A and the interval B do not overlap each other in time sequence, and the frame period may be a time for the touch display panel to completely display a screen, which is approximately a time for scanning all gate lines. The driving signal TX is a driving signal when the touch display panel 100, 300, 400, or 500 detects a touch position and detects a touch pressure, and because the driving signal TX is transmitted to the electrode layer 140, the electrode layer 120 and the electrode layer 160 would respectively output sensing signals RX-TP and RX-F correspondingly. The voltage level of the sensing signal RX-TP is related to a variation of the capacitance variation C1, and the voltage level of the sensing signal RX-F is related to a variation of the capacitance variation C2. The touch display panel 100, 300, 400, or 500 may judge a change of the capacitance variation C1 according to the sensing signal RX-TP, and further judges whether a touch event occurs in the touch display panel 100, 300, 400, or 500 according to the change of the capacitance variation C1, thus determines a touch position of the touch event, and may output coordinates of the touch position. In this embodiment, when detecting a touch position, the touch display panel 100, 300, 400, or 500 may detect a change of the capacitance variation C1 between the electrode layer 120 and the electrode layer 140 in a mutual-capacitance sensing manner, so as to judge a touched position of the touch display panel 100, 300, 400, or 500. The action that the touch display panel 100, 300, 400, or 500 detects touch position may be executed in both of the intervals A and B, and may also be executed in only one of the intervals A and B. In addition, the touch display panel 100, 300, 400, or 500 may judge a change of the capacitance variation C2 according to the sensing signal RX-F, and further judges a magnitude of a touch pressure borne by the touch display panel 100, 300, 400, or 500 at the touch position according to the change of the capacitance variation C2. In the interval A, the sensing signal RX-F may be output from the electrode layer 160 to the control unit, so as to detect, in a mutual-capacitance sensing manner, a variation of the capacitance variation C2 generated because the dielectric layer 150 is deformed, and further, detect a touch pressure at the touch position according to the variation of the capacitance variation C2; and in the interval B, the common voltage VCOM is provided to the electrode layer 160 to execute a display function. Therefore, by means of the sensing and driving method 700, on the one hand, the touch display panel 100, 300, 400, or 500 may detect a touch position and execute a display function at the same time, so that touch control efficiency thereof is improved; and on the other hand, the touch display panel 100, 300, 400, or 500 may detect a touch position and detect a touch pressure at the same time, so that touch control efficiency thereof is improved. However, detecting a touch position, executing a display function, and detecting a touch pressure may be executed separately at different times, the present disclosure is not limited thereto, and any one applicable to a driving method of the touch display panel of the present disclosure shall fall within a scope to be protected by the present disclosure. In addition, because one and the same electrode layer may have double functions (for example, the electrode layer 160 may serve as a common electrode layer and an electrode layer for detecting a touch pressure), the touch display panel can be provided with a function of detecting a magnitude of an external force without using an external pressure sensor, which can relatively reduce adhering procedures of a touch display panel.

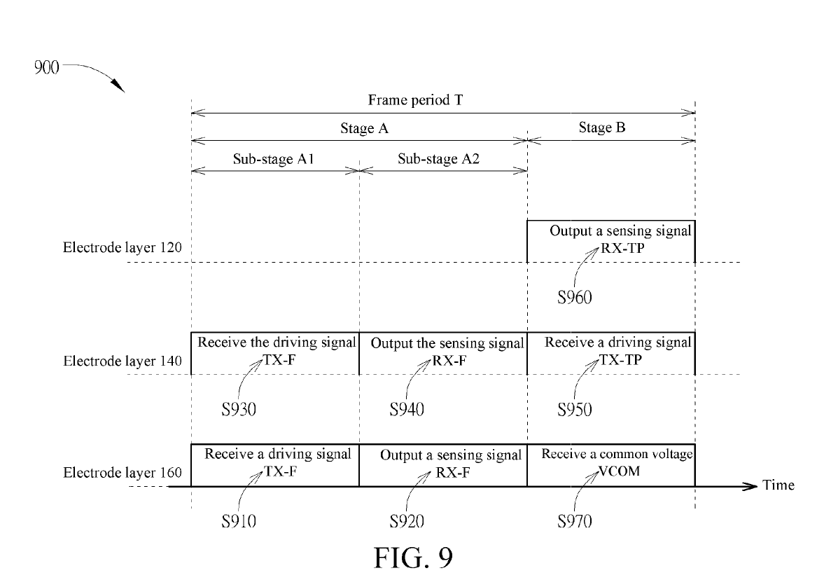

Referring to FIG. 8 and FIG. 9, FIG. 8 illustrates a relevant signal of a touch display panel (the touch display panels 100, 300, 400, and 500 as stated above) according to another embodiment of the present disclosure, and FIG. 9 illustrates a sensing and driving method 900 according to another embodiment of the present disclosure, which is applicable to a touch display panel having an architecture of three layers of sensing electrodes (the touch display panels 100, 300, 400, and 500 as stated above). The sensing and driving method 900 includes:

Step S910: In a sub-interval A1 of a interval A, an electrode layer 160 receives a driving signal TX-F from a control unit, that is, the control unit provides the driving signal TX-F to the electrode layer 160.

Step S920: In a sub-interval A2 of the interval A, the electrode layer 160 outputs a sensing signal RX-F to the control unit, so as to detect a touch pressure at a touch position.

Step S930: In the sub-interval A1 of the interval A, an electrode layer 140 receives a driving signal TX-F from the control unit, that is, the control unit provides the driving signal TX-F to the electrode layer 140.

Step S920: In the sub-interval A2 of the interval A, the electrode layer 140 outputs a sensing signal RX-F to the control unit, so as to detect a magnitude of the touch pressure at the touch position.

Step S930: In a interval B, the electrode layer 140 receives a driving signal TX-TP from the control unit, that is, the control unit provides the driving signal TX-TP to the electrode layer 140.

Step S960: In the interval B, the electrode layer 120 outputs a sensing signal RX-TP to the control unit, so as to detect the touch position.

Step S940: In the interval B, the electrode layer 160 receives a common voltage VCOM provided by the control unit. The the sub-interval A1, sub-interval A2, and interval B do not overlap each other in time sequence, and the common voltage VCOM has a constant voltage level provided for the touch display panel to execute pixel driving.

In this embodiment, steps S910 to S970 may be executed once in each frame period T of the touch display panels 100, 300, 400, and 500, that is, the touch display panels 100, 300, 400, and 500 periodically execute steps S910 to S970. Each frame period T includes a interval A and a interval B, the interval A further includes a sub-intervals A1 and A2, and the sub-interval A1, sub-interval A2, and interval B do not overlap each other in time sequence. In the interval A, the touch display panels 100, 300, 400, and 500 detect a touch pressure at a touch position; and in the interval B, the touch display panels 100, 300, 400, and 500 detect the touch position and provide a common voltage VCOM to execute a pixel driving operation. In this embodiment, the function of steps S910 to S920 is the same as that of steps S930 and S940, both for detecting a touch pressure. However, in others embodiments of the present disclosure, steps S910 to S920 can be omitted or steps S930 and S940 can be omitted, and the rest steps are reserved. The driving signal TX-F is a driving signal when the touch display panel 100, 300, 400, or 500 detects a touch pressure, and when the touch display panel 100, 300, 400, or 500 detects a touch pressure detect, a change of the capacitance variation C2 of the dielectric layer 150 may be detected in a self-capacitance sensing manner. When the touch display panel 100, 300, 400, or 500 detects a touch pressure in a self-capacitance sensing manner, the control unit transmits the driving signal TX-F to the electrode layer 140 or 160. When the driving signal TX-F is transmitted to the electrode layer 140 or 160 in the sub-interval A1, the electrode layer 140 or 160 correspondingly outputs a sensing signal RX-F, and the touch display panel 100, 300, 400, or 500 may judge a change of the capacitance variation C2 according to the sensing signal RX-F, and further judges a magnitude of a touch pressure borne by the touch display panel 100, 300, 400, or 500 at the touch position according to the change of the capacitance variation C2. In addition, the driving signal TX-TP is a driving signal when the touch display panel 100, 300, 400, or 500 detects a touch position, and when the driving signal TX-TP is transmitted to the electrode layer 140, the electrode layer 120 outputs a sensing signal RX-TP correspondingly. A voltage level of the sensing signal RX-TP is related to a variation of the capacitance variation C1, the touch display panel 100, 300, 400, or 500 may judge a change of the capacitance variation C1 according to the sensing signal RX-TP, and further judges whether a touch event occurs in the touch display panel 100, 300, 400, or 500 according to the change of the capacitance variation C1, thus determines a touch position of the touch event, and may output coordinates of the touch position. Therefore, by means of the sensing and driving method 900, the touch display panel 100, 300, 400, or 500 may detect a touch position and execute a display function at the same time, so that touch control efficiency thereof is improved. In addition, because one and the same electrode layer may have double functions, the touch display panel can be provided with a function of detecting a magnitude of an external force without using an external pressure sensor, which can relatively reduce adhering procedures.

### Fourth Embodiment

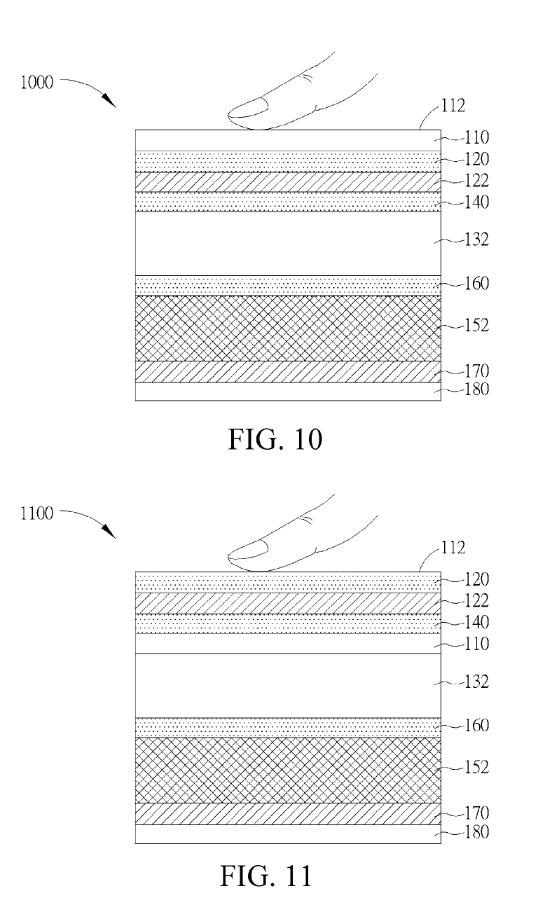

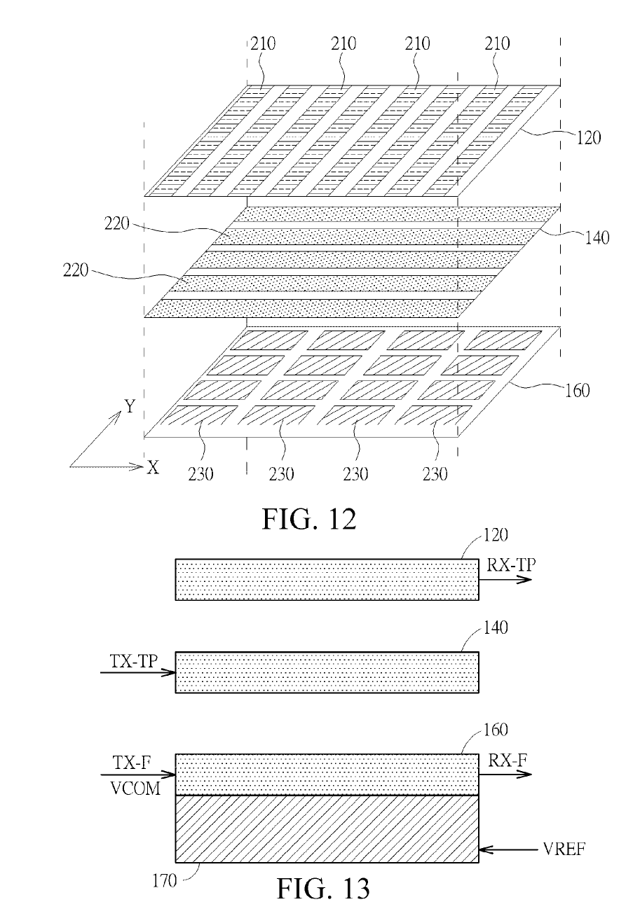

Referring to FIG. 10, FIG. 10 is a stacking diagram of a touch display panel 1000 including three electrode layers 120, 140, and 160 according to a fourth embodiment of the present disclosure. The touch display panel 1000 may be applied to a Twisted Nematic (TN) or Vertical Alignment (VA) panel and the like, whose common electrode layer is immediately adjacent to a color filter layer. The touch display panel 1000 includes an upper substrate 110, the electrode layer 120, a dielectric layer 130, the electrode layer 140, a color filter layer 132, the electrode layer 160, a dielectric layer 150, an active layer 170, and a lower substrate 180 in sequence from the top to the bottom. The dielectric layer 130 may be an insulating layer 122, and the dielectric layer 150 may be a liquid crystal layer 152. This embodiment differs from the foregoing embodiments in that the dielectric layer 150 of the touch display panel 1000 is sandwiched between the electrode layer 160 and the active layer 170. The touch display panel 1000 may also include an upper polarizer and a lower polarizer (not shown) disposed on an outer side of the touch display panel 1000. Electrode layers for detecting a touch position and detecting a touch pressure in the touch display panel 1000 are all integrated into a display panel. In addition, as shown in FIG. 12, the electrode layer 120 of the touch display panel 1000 includes a plurality of sensing electrodes 210 disposed in parallel along a Y direction, the electrode layer 140 of the touch display panel 1000 includes a plurality of sensing electrodes 220 disposed in parallel along an X direction, and the electrode layer 160 of the touch display panel 1000 includes a plurality of sensing electrodes 230 disposed in parallel along the Y direction, where the X direction and the Y direction may be perpendicular to each other on the same plane. Moreover, the active layer 1700 is a driving component layer of a display area of the touch display panel 1000 and may include a metal layer such as a data line or a scan line (not shown).

### Fifth Embodiment

Referring to FIG. 11, FIG. 11 is a stacking diagram of a touch display panel 1100 including three electrode layers 120, 140, and 160 according to a fifth embodiment of the present disclosure. The touch display panel 1100 may be applied to a Twisted Nematic (TN) or Vertical Alignment (VA) panel and the like, whose common electrode layer is immediately adjacent to a color filter layer. The touch display panel 1100 includes the electrode layer 120, a dielectric layer 130, the electrode layer 140, an upper substrate 110, a color filter layer 132, the electrode layer 160, a dielectric layer 150, an active layer 170, and a lower substrate 180 in sequence from the top to the bottom. The dielectric layer 130 may be an insulating layer 122, and the dielectric layer 150 may be a liquid crystal layer 152. In addition, as shown in FIG. 12, the electrode layer 120 of the touch display panel 1000 includes a plurality of sensing electrodes 210 disposed in parallel along a Y direction, the electrode layer 140 of the touch display panel 1000 includes a plurality of sensing electrodes 220 disposed in parallel along an X direction, and the electrode layer 160 of the touch display panel 1000 includes a plurality of sensing electrodes 230 disposed in parallel along the Y direction, where the X direction and the Y direction may be perpendicular to each other on the same plane.

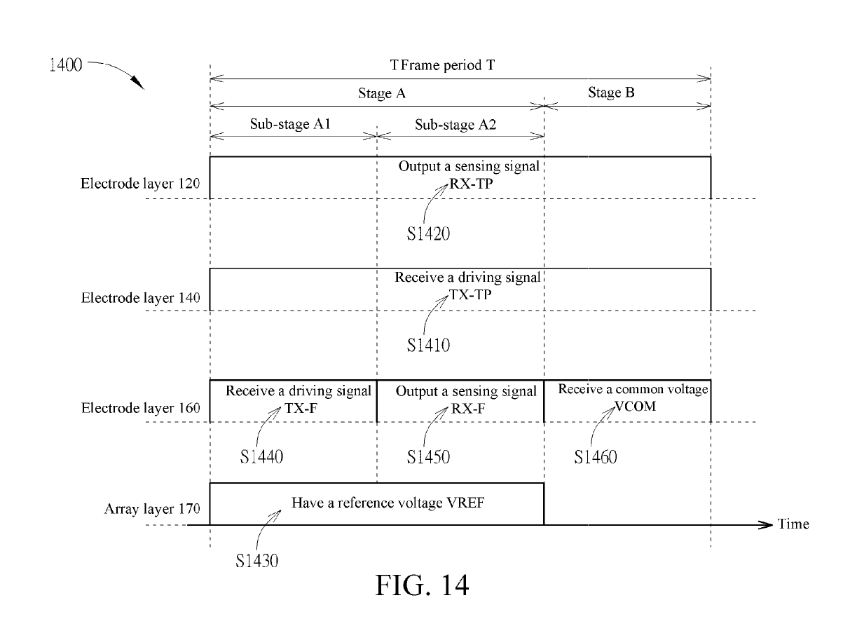

Referring to FIG. 13 and FIG. 14, FIG. 13 illustrates a relevant signal of a touch display panel (the touch display panel 100, 300, 400,500, 1000, and 11000 as stated above) according to another embodiment of the present disclosure, and FIG. 14 illustrates a sensing and driving method 1400 according to another embodiment of the present disclosure, which is applicable to a touch display panel having an architecture of three layers of sensing electrodes (the touch display panel 100, 300, 400,500, 1000, and 11000 as stated above). The sensing and driving method 1400 includes:

Step S1410: An electrode layer 140 receives a driving signal TX-TP from a control unit, that is, the control unit provides the driving signal TX-TP to the electrode layer 140.

Step S1420: An electrode layer 120 outputs a sensing signal RX-TP to the control unit, so as to detect a touch position.

Step S1430: In a interval A, the control unit provides a reference voltage VREF to an active layer 170, where the reference voltage VREF has a constant voltage level.

Step S1440: In a sub-interval A1 of the interval A, an electrode layer 160 receives a driving signal TX-F from the control unit, that is, the control unit provides the driving signal TX-F to the electrode layer 160.

Step S1450: In a sub-interval A2 of the interval A, the electrode layer 160 outputs a sensing signal RX-F to the control unit, so as to detect a magnitude of a touch pressure at the touch position.

Step S1460: In a interval B, the electrode layer 160 receives a common voltage VCOM provided by the control unit. The the sub-interval A1,sub-interval A2, and interval B do not overlap each other in time sequence, and the common voltage VCOM has a constant voltage level provided for the touch display panel to execute pixel driving.

In this embodiment, steps S1410 to S1460 may be executed once in each frame period T of the touch display panels 100, 300, 400, 500, 1000, and 1100 that is, the touch display panels 100, 300, 400, 500, 1000, and 1100 periodically execute steps S1410 to S1460. Each frame period T includes a interval A and a interval B, the interval A further includes a sub-intervals A1 and A2, and the sub-interval A1,sub-interval A2, and interval B do not overlap each other in time sequence. The driving signal TX-TP is a driving signal when the touch display panel 100, 300, 400, 500, 1000, or 1100 detects a touch position, and when the driving signal TX-TP is transmitted to the electrode layer 140, the electrode layer 120 outputs a sensing signal RX-TP correspondingly. A voltage level of the sensing signal RX-TP is related to a variation of the capacitance variation C1, the touch display panel 100, 300, 400, or 500 may judge a change of the capacitance variation C1 according to the sensing signal RX-TP, and further judges whether a touch event occurs in the touch display panel 100, 300, 400, 500, 1000, or 1100 according to the change of the capacitance variation C1, thus determines a touch position of the touch event, and may output coordinates of the touch position. In addition, the driving signal TX-F is a driving signal when the touch display panel 100, 300, 400, 500, 1000, or 1100 detects a touch pressure, and when the touch display panel 100, 300, 400, 500, 1000, or 1100 detects a touch pressure detect, a change of the capacitance variation C2 of the dielectric layer 150 may be detected in a self-capacitance sensing manner. When the touch display panel 100, 300, 400, 500, 1000, or 1100 detects a touch pressure in a self-capacitance sensing manner, the control unit may provide a reference voltage having a constant level to a data line, a scan line, or the like of a metal layer (not shown) in the active layer 170 and the control unit also transmits the driving signal TX-F to the electrode layer 160. When the driving signal TX-F is transmitted to the electrode layer 160 in the sub-interval A1, the electrode layer 140 correspondingly outputs a sensing signal RX-F, and the touch display panel 100, 300, 400, 500, 1000, or 1100 may judge a change of the capacitance variation C2 according to the sensing signal RX-F, and further judges a magnitude of a touch pressure borne by the touch display panel 100, 300, 400, 500, 1000, or 1100 at the touch position according to the change of the capacitance variation C2.

By means of a designing manner of three electrode layers, the touch display panels 100, 300, 400, 500, 1000, and 1100 integrate a display function, a touch position detecting function, and a touch pressure detecting function. Time-multiplexing of the electrode layer 160 is used to provide the common voltage VCOM and receive the sensing signal RX-F, so that the electrode layer 160 can be shared for display driving and touch pressure detecting, thereby producing an effect of thinning a touch control display device. In addition, the electrode layer 140 is disposed between the electrode layer 120 and the electrode layer 160, so that the electrode layer 140 may be used to input driving signals for detecting a touch position and detecting a touch pressure, so as to produce an effect of thinning the touch display panels 100, 300, 400, 500, 1000, and 1100. The inventive concept disclosed in the present disclosure is not only limited to an LCD, and as long as a display panel includes a common electrode layer capable of providing a signal and a common voltage VCOM, the display panel may execute display driving and touch pressure detecting functions in a time-multiplexing manner.

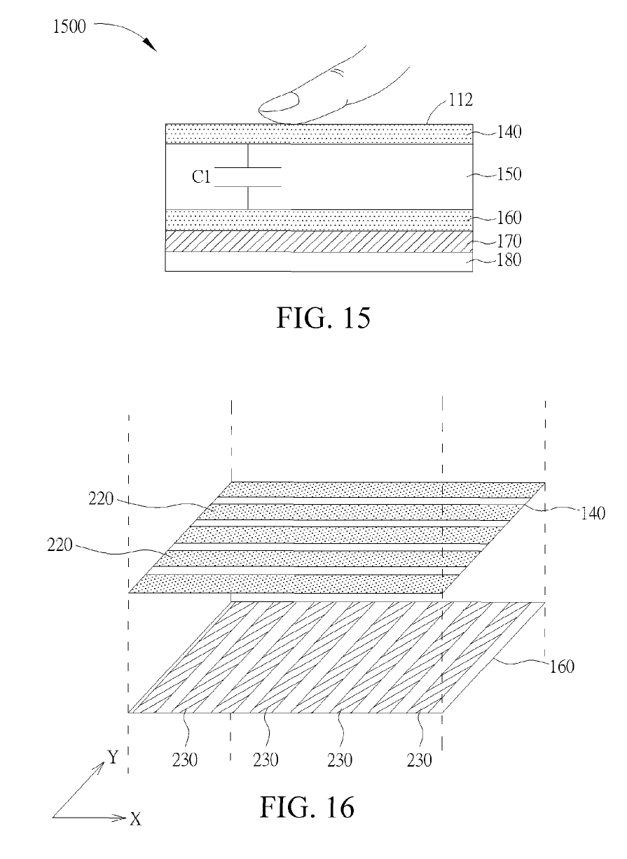

Referring to FIG. 15, FIG. 15 is a stacking diagram of a touch display panel 1500 including two electrode layers according to an embodiment of the present disclosure. The touch display panel 1500 includes an electrode layer 140, a dielectric layer 150, an electrode layer 160, an active layer 170, and a lower substrate 180 from the top to the bottom. The dielectric layer 150 is disposed between the electrode layer 140 and the electrode layer 160, the electrode layers 140 and 160 may be transparent electrodes (ITO), and the active layer 170 is formed over the substrate 180. In addition, as shown in FIG. 16, the electrode layer 140 includes a plurality of sensing electrodes 220 disposed in parallel along an X direction, the electrode layer 160 includes a plurality of sensing electrodes 230 disposed in parallel along a Y direction, the electrode layer 160 may serve as a common electrode layer, and when the touch display panel 1500 executes pixel driving to display a screen, a common voltage VCOM may be applied to the electrode layer 160. The dielectric layer 150 includes a flexible material, and when the touch display panel 1500 is touched, the dielectric layer 150 may be deformed.

A sensing and driving manner of the touch display panel 1500 is described in the following. When a user touches a touch control surface 112 of the touch display panel 1500 with a finger or a stylus, so as to cause the capacitance variation C1 to change between the electrical field between the electrode layer 140 and the electrode layer 160 changes, the touch display panel 1500 can determine a touch event and a touch position according to the change of the capacitance variation C1. Moreover, in a interval other than a interval of detecting a touch position, the touch display panel 1500 can judge a touch pressure at the touch position according to the change of the capacitance variation C1. It is worth noting that the electrode layer 160 may serve as an electrode layer during touch pressure detection, touch position detection, and display driving in a time-multiplexing manner, so that the thickness of the touch display panel 1500 can be reduced.

### Sixth Embodiment

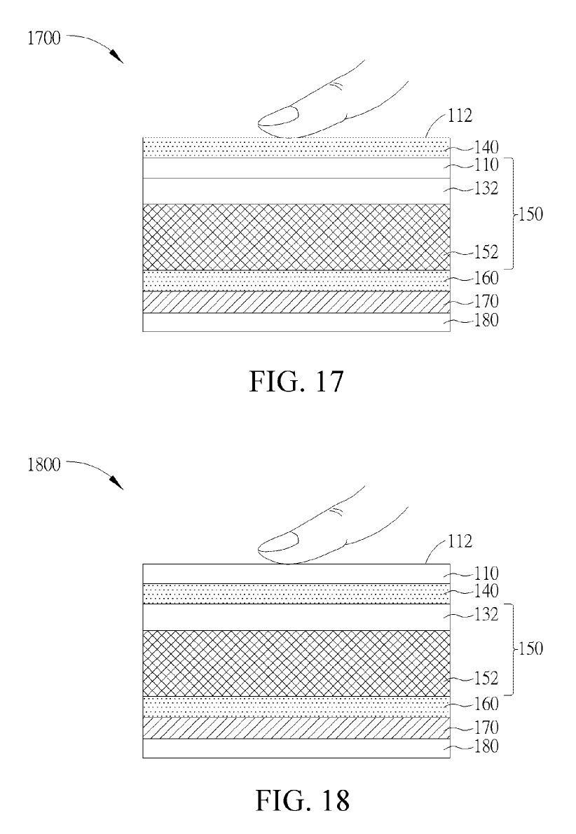

Referring to FIG. 17, FIG. 17 is a stacking diagram of a touch display panel 1700 including two electrode layers according to a sixth embodiment of the present disclosure. The touch display panel 1700 may be applied to an In Plane Switching (IPS) display panel and the like, whose common electrode layer is immediately adjacent to an active layer. The touch display panel 1700 includes an electrode layer 140, a dielectric layer 150, an electrode layer 160, an active layer 170, and a lower substrate 180 from the top to the bottom. The dielectric layer 150 may include an upper substrate 110, a color filter layer 132, and a liquid crystal layer 152. The dielectric layer 150 includes a flexible material, and when the touch display panel 1700 is touched, the dielectric layer 150 may be deformed. In addition, the touch display panel 1700 may also include an upper polarizer and a lower polarizer (not shown) disposed on two sides of the touch display panel 1700. As shown in FIG. 16, the electrode layer 140 includes a plurality of sensing electrodes 220 disposed in parallel along an X direction, and the electrode layer 160 includes a plurality of sensing electrodes 230 disposed in parallel along a Y direction, where the X direction and the Y direction may be orthogonal or perpendicular to each other on the same plane. The active layer 170 is a driving component layer of a display area of the touch display panel 1700 and may include a metal layer such as a data line or a scan line (not shown).

### Seventh Embodiment

Referring to FIG. 18, FIG. 18 is a stacking diagram of a touch display panel 1800 including two electrode layers according to a seventh embodiment of the present disclosure. The touch display panel 1800 may be applied to an In Plane Switching (IPS) display panel and the like, whose common electrode layer is immediately adjacent to an active layer. The touch display panel 1800 includes an upper substrate 110, an electrode layer 140, a dielectric layer 150, an electrode layer 160, an active layer 170, and a lower substrate 180 from the top to the bottom. The dielectric layer 150 includes a flexible material, and when the touch display panel 1800 is touched, the dielectric layer 150 may be deformed. In addition, as shown in FIG. 16, the electrode layer 140 includes a plurality of sensing electrodes 220 disposed in parallel along an X direction, and the electrode layer 160 includes a plurality of sensing electrodes 230 disposed in parallel along a Y direction, where the X direction and the Y direction may be perpendicular to each other on the same plane. Electrode layers for detecting a touch position and detecting a touch pressure in the touch display panel 1800 are all integrated into a display panel.

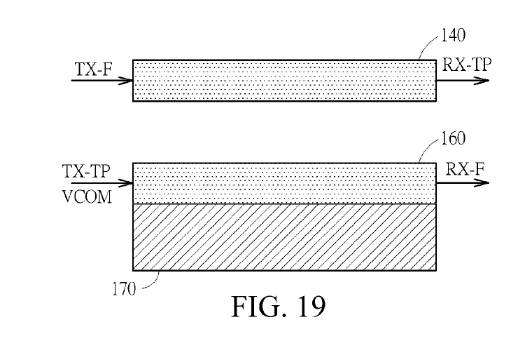

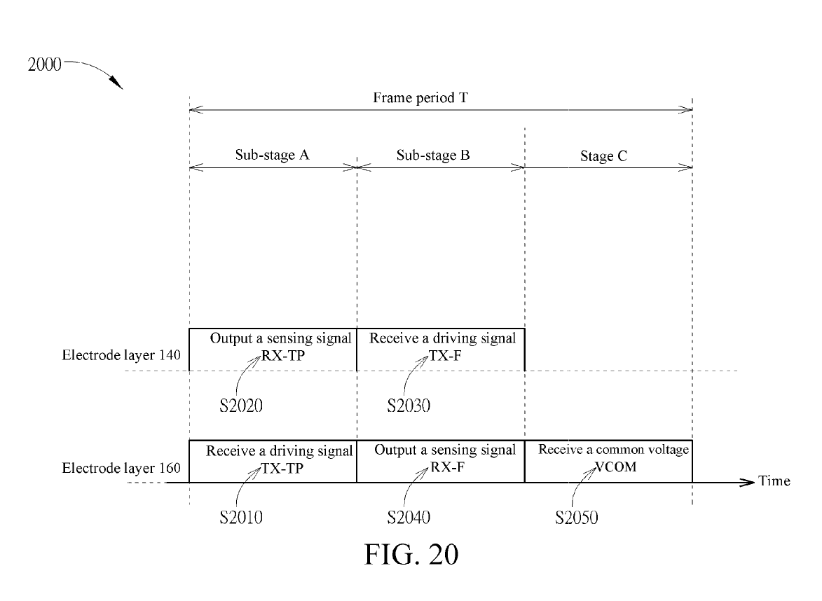

Detailed acting manners of the touch display panels 1700 and 1800 including two electrode layers in the sixth embodiment and seventh embodiment are described in the following. Referring to FIG. 19 and FIG. 20, FIG. 19 illustrates a relevant signal of a touch display panel (the touch display panels 1700 and 1800 as stated above) according to an embodiment of the present disclosure, and FIG. 20 illustrates a sensing and driving method 2000 according to an embodiment of the present disclosure, which is applicable to a touch display panel having an architecture of two layers of sensing electrodes (the touch display panels 1700 and 1800 as stated above). The sensing and driving method 2000 includes:

Step S2010: In a interval A, an electrode layer 160 receives a driving signal TX-TP from a control unit, that is, the control unit provides the driving signal TX-TP to the electrode layer 160.

Step S2020: In the interval A, an electrode layer 140 outputs a sensing signal RX-TP to the control unit (that is, receiving the sensing signal RX-TP from the electrode layer 140), so as to detect a touch position.

Step S2030: In a interval B, the electrode layer 140 receives a driving signal TX-F from the control unit, that is, the control unit provides the driving signal TX-F to the electrode layer 140.

Step S2040: In the interval B, the electrode layer 160 outputs a sensing signal RX-F to the control unit (that is, the control unit receives the sensing signal RX-F from the electrode layer 160), so as to detect a magnitude of a touch pressure.

Step S2050: In a interval C, the control unit provides a common voltage VCOM to the electrode layer 160. The intervals A, B, and C do not overlap each other in time sequence, and the common voltage VCOM has a constant voltage level provided for the touch display panel to execute pixel driving.

In this embodiment, steps S2010 to S2050 may be executed once in each frame period T of the touch display panels 1700 and 1800, that is, the touch display panels 1700 and 1800 periodically execute steps S2010 to S2050. In the interval A, the driving signal TX-TP is transmitted to the electrode layer 160, and the sensing signal RX-TP is received by using the electrode layer 140. Moreover, a change of a capacitance variation C1 between the electrode layer 140 and the electrode layer 160 is detected in a mutual-capacitance sensing manner to judge whether a touch event occurs in the touch display panel 1700 or 1800, so as to determine a touch position and output coordinates of the touch position. In the interval B, the driving signal TX-F is transmitted to the electrode layer 140, and the sensing signal RX-F is received by using the electrode layer 160. Moreover, a gap change (namely, the change of capacitance variation C1) of the dielectric layer 150 is detected in a mutual-capacitance sensing manner to detect a magnitude of a touch pressure of the touch display panel 1700 or 1800. In the interval C, the common voltage VCOM is provided to the electrode layer 160 to execute a display function of the touch display panel 1700 or 1800.

### Eighth Embodiment

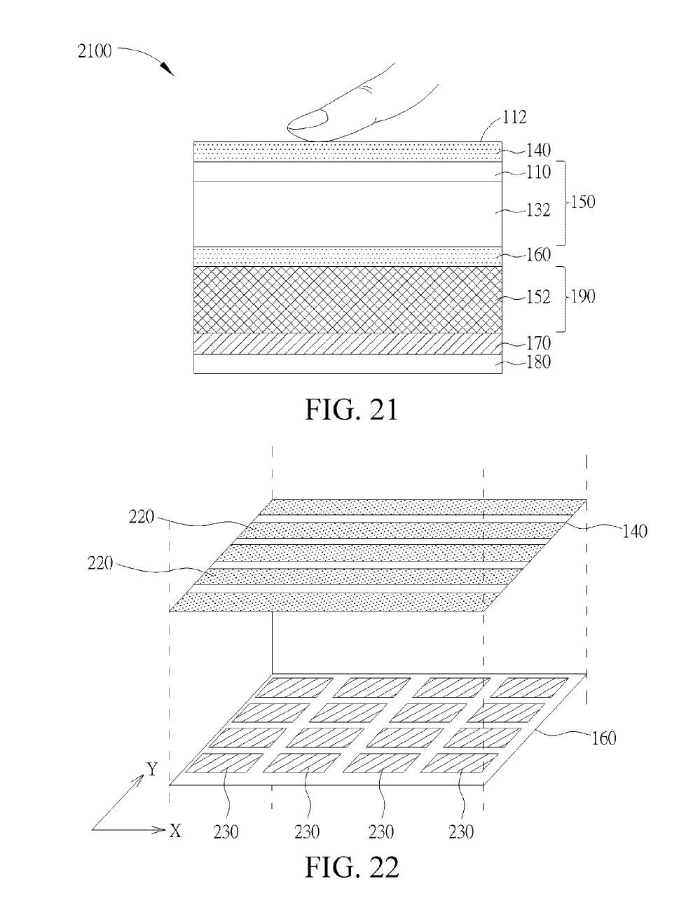

Referring to FIG. 21, FIG. 21 is a stacking diagram of a touch display panel 2100 including two electrode layers according to an eighth embodiment of the present disclosure. The touch display panel 2100 may be applied to a Twisted Nematic (TN) or Vertical Alignment (VA) panel and the like, whose common electrode layer is immediately adjacent to a color filter layer. The touch display panel 2100 includes an electrode layer 140, a dielectric layer 150, an electrode layer 160, a dielectric layer 190, an active layer 170, and a substrate 180 from the top to the bottom. The dielectric layer 150 may include an upper substrate 110 and a color filter layer 132, and the dielectric layer 190 may include a liquid crystal layer 152. In addition, the touch display panel 2100 may also include an upper polarizer and a lower polarizer (not shown) disposed on an outer side of the touch display panel 2100. In addition, as shown in FIG. 22, the electrode layer 140 includes a plurality of sensing electrodes 220 disposed in parallel along an X direction, and the electrode layer 160 includes a plurality of sensing electrodes 230 disposed in a matrix manner. The active layer 170 is a driving component layer of a display area of the touch display panel 2100 and may include a metal layer such as a data line or a scan line (not shown).

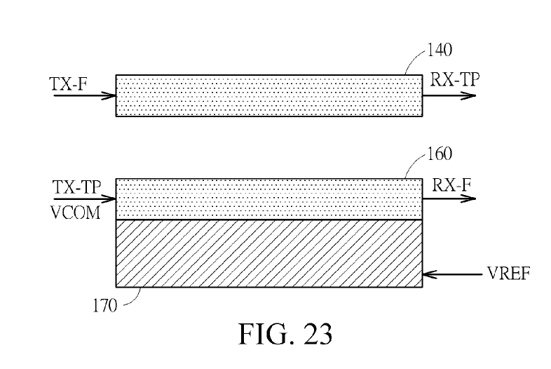

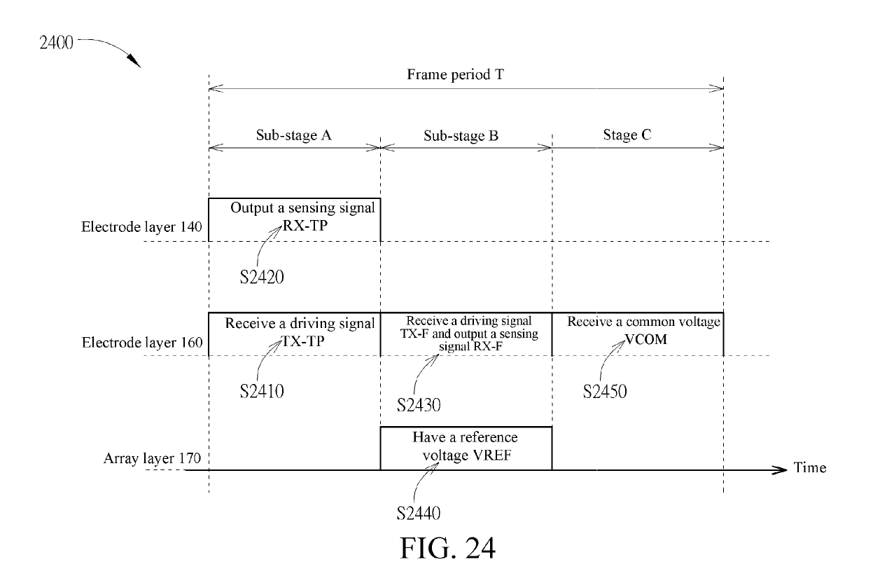

A detailed acting manner of the touch display panel 2100 including two electrode layers in the eighth embodiment is described in the following. Referring to a control unit of FIG. 23 and FIG. 24, FIG. 23 illustrates a relevant signal of a touch display panel 2100 according to an embodiment of the present disclosure, and FIG. 24 illustrates a sensing and driving method 2400 according to an embodiment of the present disclosure, which is applicable to a touch display panel 2100 having an architecture of two layers of sensing electrodes. The sensing and driving method 2400 includes:

Step S2410: In a interval A, an electrode layer 160 receives a driving signal TX-TP from a control unit, that is, the control unit provides the driving signal TX-TP to the electrode layer 160.

Step S2420: In the interval A, an electrode layer 140 outputs a sensing signal RX-TP to the control unit, so as to detect a touch position.

Step S2030: In a interval B, the electrode layer 160 receives a driving signal TX-F from the control unit, and the electrode layer 160 outputs a sensing signal RX-F to the control unit, so as to detect a magnitude of a touch pressure in a self-capacitance sensing manner.

Step S2440: In the interval B, an active layer 170 is provided with a reference voltage VREF, where the reference voltage VREF has a constant voltage level.

Step S2450: In a interval C, the electrode layer 160 receives a common voltage VCOM provided by the control unit. The intervals A, B, and C do not overlap each other in time sequence, and the common voltage VCOM has a constant voltage level provided for the touch display panel to execute pixel driving.

In this embodiment, steps S2410 to S2450 may be executed once in each frame period T of the touch display panel 2100, that is, the touch display panel 2100 periodically execute steps S2410 to S2450. In the interval A, the driving signal TX-TP is transmitted to the electrode layer 160 to drive sensing electrodes 230 of the electrode layer 160 row by row along an X direction, and the sensing signal RX-TP is received by sensing electrodes 240 of the electrode 140 row by row along the X direction by using the electrode layer 140. In this way, the touch display panel 2100 detects a change of a capacitance variation C1 between the electrode layer 140 and the electrode layer 160 in a mutual-capacitance sensing manner to judge whether a touch event occurs in the touch display panel including two electrode layers, so as to determine a touch position and output coordinates of the touch position. In the interval B, the active layer 170 maintains a reference level, the driving signal TX-F is transmitted to the sensing electrodes 240 of the electrode 140, and the sensing signal RX-F is received in sequence by using the sensing electrodes 240 of the corresponding electrode 140, so as to detect a capacitance change between the electrode layer 140 and the active layer 170 caused by a gap change of the dielectric layer 190 in a mutual-capacitance sensing manner and to detect a magnitude of the touch pressure of the touch display panel 2100. In the interval C, the common voltage VCOM is provided to the electrode layer 160 to execute a display function of the touch display panel 2100. The dielectric layer 190 may include a flexible material, so that the dielectric layer 190 is deformed because the touch display panel 2100 is subject to an external force.

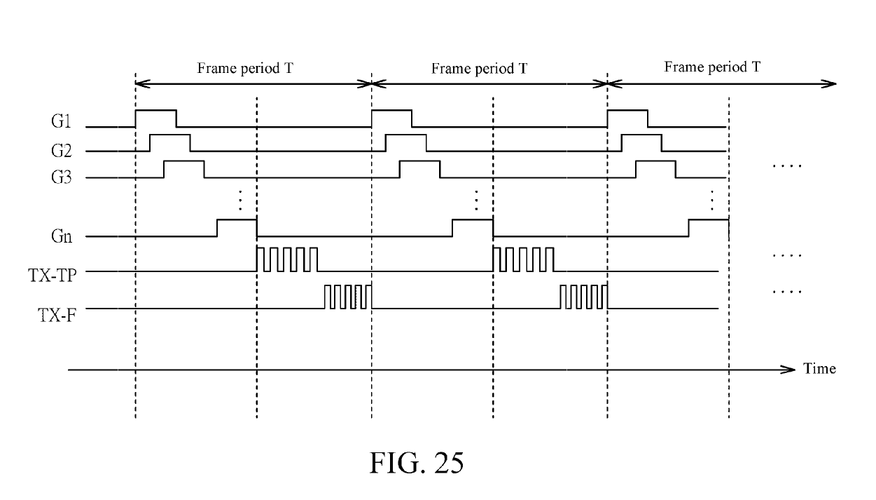

In an implementation of the present disclosure, a control unit of a touch display panel executes a touch position detecting action and a touch pressure detecting action separately once in each frame period T. Referring to FIG. 25, FIG. 25 is a sequence diagram of a relevant signal of a touch display panel according to an embodiment of the present disclosure. Gate signals G1 to Gn represent gate signals applied to the touch display panel and used to connect to a gate line, and are used to enable the touch display panel to execute a display function, and the foregoing driving signal TX-TP and driving signal TX-F are transmitted to a corresponding electrode layer 120, 140, or 160 before each frame period T ends, so as to execute a touch position detecting action and a touch pressure detecting action.

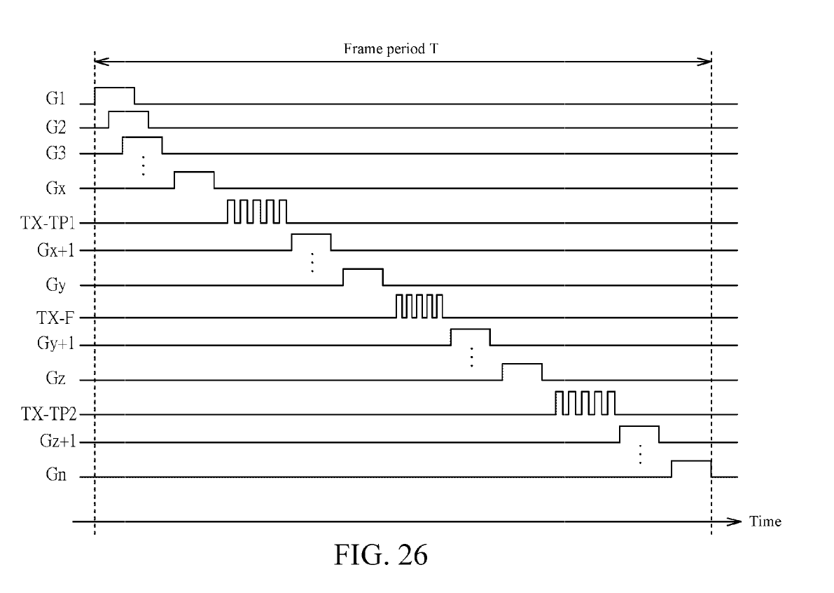

In addition, in another implementation of the present disclosure, the touch position detecting action to be executed in each frame period T is executed by interval, and the touch pressure detecting action to be executed in each frame period T is executed at one time. Referring to FIG. 26, FIG. 26 is a sequence diagram of a relevant signal of a touch display panel according to another embodiment of the present disclosure. The driving signal TX-TP is divided into driving signals TX-TP1 and TX-TP2, and the touch display panel is also divided into two sensing areas, the driving signal TX-TP1 is used to drive an electrode layer of one sensing area of the two sensing areas to detect a touch position, and the driving signal TX-TP2 is used to drive the other sensing area of the two sensing areas to detect a touch position. In each frame period T, first the driving signal TX-TP1 is transmitted to the corresponding electrode layer 120, 140, or 160 after pulses of gate signals G1 to Gx have passed, then, the driving signal TX-F is transmitted to the corresponding electrode layer 120, 140, or 160 after pulses of gate signals Gx+1 to Gy have passed, and finally, the driving signal TX-TP2 is transmitted to the corresponding electrode layer 120, 140, or 160 after pulses of gate signals Gy+1 to Gz have passed. After the driving signal TX-TP2 is transmitted, the control unit outputs pulses of gate signals Gz+1 to Gn, so as to complete driving of the touch display panel in the one frame period T, where, x, y, z, and n are all positive integers, and x, y, and z are all less than n.

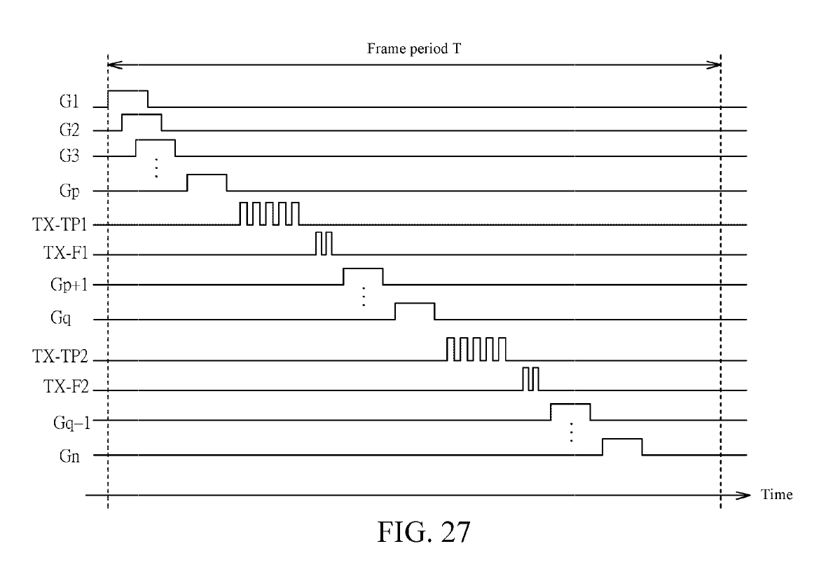

In addition, in another implementation of the present disclosure, the touch position detecting action to be executed and the touch pressure detecting action to be executed in each frame period T are both executed by interval. Referring to FIG. 27, FIG. 27 is a sequence diagram of a relevant signal of a touch display panel according to another embodiment of the present disclosure. The driving signal TX-TP is divided into driving signals TX-TP1 and TX-TP2, the driving signal TX-F is divided into driving signals TX-F2 and TX-F2, and the touch display panel is also divided into two sensing areas. The driving signal TX-TP1 is used to sense a touch position of one sensing area of the two sensing areas, and the driving signal TX-TP2 is used to sense a touch position of the other sensing area. Similarly, the driving signal TX-F1 is used to sense a magnitude of a touch pressure in one sensing area of the two sensing areas, and the driving signal TX-F2 is used to sense a magnitude of a touch pressure in the other sensing area. In each frame period T, first the driving signal TX-TP1 and the driving signal TX-F2 are transmitted to the corresponding electrode layer 120, 140, or 160 after pulses of gate signals G1 to Gp have passed, and then the driving signal TX-TP2 and the driving signal TX-F2 are transmitted to the corresponding electrode layer 120, 140, or 160 after pulses of gate signals Gp+1 to Gq have passed. After the driving signal TX-TP2 and the driving signal TX-F2 are transmitted, the control unit outputs pulses of gate signals Gq+1 to Gn, so as to complete driving of the touch display panel in the one frame period T, where, p, q, and n and n are all positive integers, and p and q are all less than n.

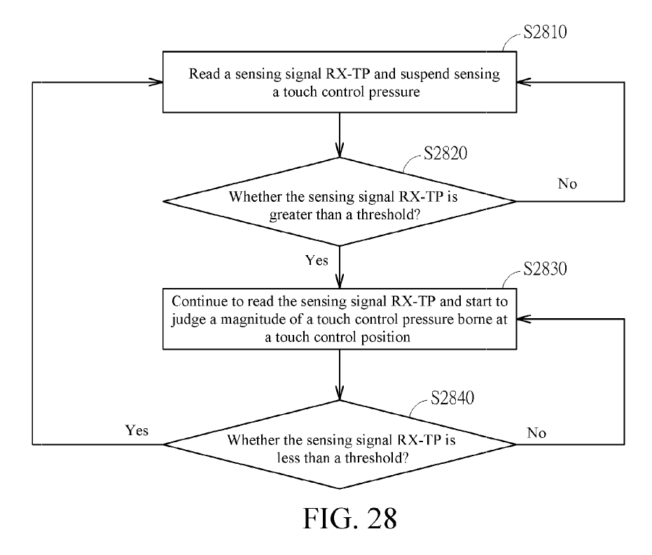

Referring to FIG. 28, FIG. 28 is a flowchart of a sensing and driving method according to an embodiment of the present disclosure. First, in step S2810, a control unit of a touch display panel reads a sensing signal RX-TP, and suspends detecting a touch pressure, that is, the control unit of the touch display panel suspends outputting a driving signal TX-F and stops receiving a sensing signal RX-F. Subsequently, in step S2820, the control unit of the touch display panel judges whether a voltage level of the sensing signal RX-TP is greater than a preset threshold, and if the voltage level of the sensing signal RX-TP is greater than the preset threshold, indicating that a touch control surface 112 is touched, step S2830 is executed; and otherwise, it is indicated that the touch control surface 112 is not touched, step S2810 is executed again. In step S2820, the control unit of the touch display panel continues to read the sensing signal RX-TP and starts to judge a magnitude of a touch pressure borne at the touch position, that is, the control unit of the touch display panel starts to output a driving signal TX-F and starts to receive a sensing signal RX-F. Afterward, in step S2840, the control unit of the touch display panel judges whether the voltage level of the sensing signal RX-TP is less than a preset threshold, and if the voltage level of the sensing signal RX-TP is less than the preset threshold, indicating that the touch control surface 112 is not touched again, step S2830 is executed; and otherwise, it is indicated that the touch control surface 112 is continuously touched, step S2810 is executed again. In this embodiment, because before it is detected that the touch control surface 112 is touched, the control unit of the touch display panel suspends outputting the driving signal TX-F and stops receiving the sensing signal RX-F, an energy saving effect can be achieved.

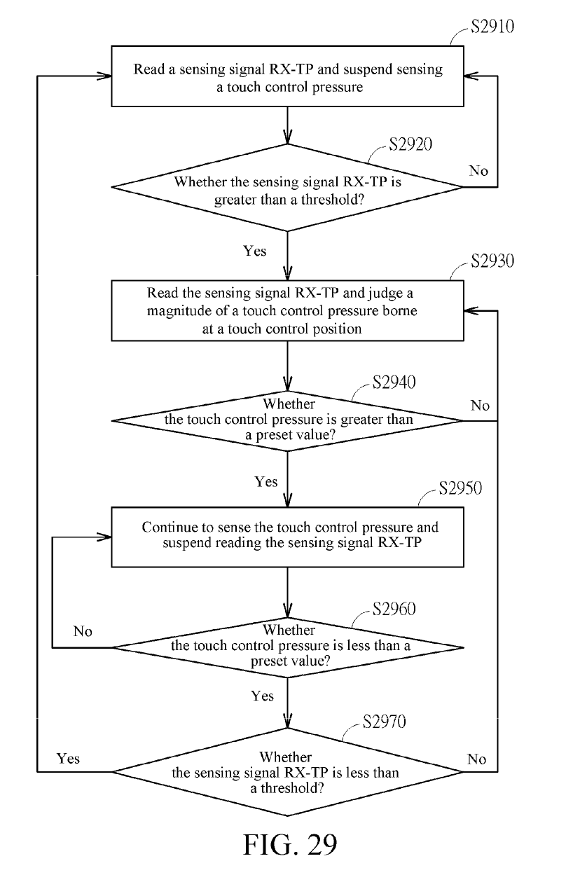

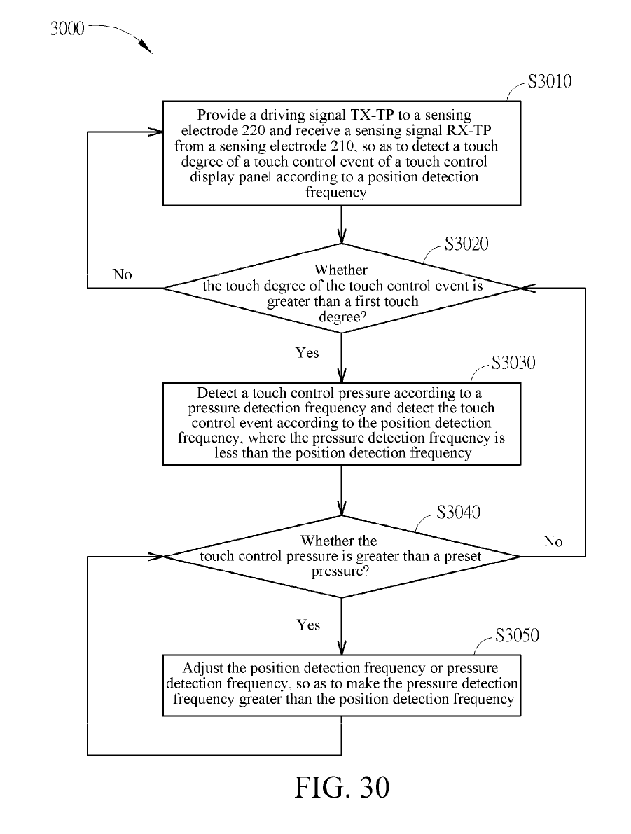

Referring to FIG. 29, FIG. 29 is a flowchart of a sensing and driving method according to another embodiment of the present disclosure. First, in step S2910, a control unit of a touch display panel reads a sensing signal RX-TP, and suspends detecting a touch pressure, that is, the control unit of the touch display panel suspends outputting a driving signal TX-F and stops receiving a sensing signal RX-F. Subsequently, in step S2920, the control unit of the touch display panel judges whether a voltage level of the sensing signal RX-TP is greater than a default threshold, and if the voltage level of the sensing signal RX-TP is greater than the default threshold, indicating that a touch control surface 112 is touched, step S2930 is executed; and otherwise, it is indicated that the touch control surface 112 is not touched, step S2910 is executed again. In step S2920, the control unit of the touch display panel continues to read the sensing signal RX-TP and starts to judge a magnitude of a touch pressure borne at the touch position, that is, the control unit of the touch display panel starts to output a driving signal TX-F and starts to receive a sensing signal RX-F. Afterward, in step S2940, the control unit of the touch display panel judges whether the touch pressure at the touch position is greater than a preset value, and if the touch pressure at the touch position is greater than the preset value, step S2950 is executed; and otherwise, step S2930 is executed again. In step S2950, because the detected touch pressure is greater than a preset value, which enables the control unit of the touch display panel to judge a touch position of the touch control surface 112 according to the detected touch pressure, the control unit of the touch display panel can suspend outputting the driving signal TX-TP and continuously sense a touch pressure. Because outputting of the driving signal TX-TP can be suspended, an energy saving effect can be achieved. Then, in step S2960, the control unit of the touch display panel judges whether the subsequently detected touch pressure is less than a preset value, and if the touch pressure at the touch position is less than the preset value, step S2970 is executed; and otherwise, step S2950 is executed again. In step S2970, the control unit of the touch display panel first resumes outputting the driving signal TX-TP and receiving the sensing signal RX-TP, and judges whether the sensing signal RX-TP is less than the preset threshold, and if the sensing signal RX-TP is less than the preset threshold, indicating that the touch control surface 112 is not touched, step S2910 is executed; and otherwise, it is indicated that the touch control surface 112 is currently touched, step S2930 is executed again. Referring to FIG. 30, FIG. 30 is a flowchart of a sensing and driving method 3000 according to still another embodiment of the present disclosure, which is applicable to a touch display panel having functions for detecting a touch pressure and detecting a touch position such as touch display panels 100, 300, 400, 500, 1000, 1100, 1500, 1700, 1800, and 2100. The sensing and driving method 3000 includes:

Step S3010: Provide a driving signal TX-TP to a sensing electrode 220 and receive a sensing signal RX-TP from a sensing electrode 210, so as to detect a touch intensity of a touch event of a touch display panel according to a position detection frequency. The position detection frequency is a reciprocal of a time for executing touch position detection, for example, detection of a touch position is executed N times per second (that is, N/s), where N is a positive integer. In addition, a basis for judging a touch intensity of a touch event may be a threshold (which may be a voltage, a magnitude of a current, or the like) of the sensing signal RX-TP, and when the sensing signal RX-TP is greater than a first signal threshold, it could be determined that the touch intensity of the touch event is greater than a first touch intensity.

Step S3020: Judge whether the touch intensity of the touch event is greater than a first touch intensity. If the touch intensity of the touch event is greater than the first touch intensity, step S3030 is executed; and otherwise, step S3010 is executed again.

Step S3030: Detect a touch pressure according to a pressure detection frequency and detect the touch event according to the position detection frequency. The pressure detection frequency is a reciprocal of a time for executing touch pressure detection, for example, detection of a touch pressure is executed Q times per second (that is, Q/s), where Q is a positive integer. In addition, in step S3030, the pressure detection frequency is less than the position detection frequency.

Step S3040: Judge whether the touch pressure is greater than a preset pressure. A basis for determining whether the touch pressure is greater than the preset pressure may be a signal threshold of the sensing signal RX-F, and when the signal of the sensing signal RX-F is greater than a specific signal threshold, it could be determined that the touch pressure is greater than the preset pressure.

Step S3050: Adjust the position detection frequency or pressure detection frequency, so as to make the pressure detection frequency greater than the position detection frequency; and afterward, S3040 is executed again.

Actions of the sensing and driving method 3000 is described in detail below, where a touch control display device 100 is used as an example. In step S3010, a control unit (not shown) of a touch display panel 100 detects a touch event according to a position detection frequency without detecting a touch pressure, that is, the control unit only provides a driving signal TX-TP to an electrode layer 140 and receives a sensing signal RX-TP from an electrode layer 120; in step S3020, the control unit judges whether a touch intensity of the touch event is greater than a first touch intensity; in step S3030, when it is judged that the touch intensity of the touch event is greater than the first touch intensity, that is, when the touch display panel 100 has a touch event occurred and effectively outputs a touch position, touch pressure detection is executed according to a pressure detection frequency and the touch event is detected according to a continuous position detection frequency, where the pressure detection frequency is less than the position detection frequency, that is, a touch pressure function is executed at a frequency lower than the position detection frequency; in step S3040, the control unit receives a sensing signal RX-F from the touch display panel 100 to judge whether a touch pressure is greater than a preset pressure; and in step S3050, when the sensing signal RX-F is greater than the preset pressure, the position detection frequency or pressure detection frequency is adjusted to make the pressure detection frequency greater than the position detection frequency, that is, the touch pressure function is executed at a frequency higher than the position detection frequency.

The sensing and driving method 3000 may also include: (1) the control unit judges whether the sensing signal RX-TP is greater than a second touch intensity, where the second touch intensity may be greater than the first touch intensity, that is, a pressure applied by a finger or a stylus to the touch display panel 100 is greater than the second touch intensity; and (2) when the touch event is greater than the second touch intensity, a touch pressure of an active area is detected only in an active area of the touch event. In this way, after the touch display panel 100 detects the active area of the touch event, it could be determined that the touch display panel 100 is under touch control of an external force only in the active area, so that touch pressure detection is executed only in the active area of the touch event of the touch display panel 10; and it is unnecessary to additionally detect a touch pressure in an inactive area, which reduces energy consumption.

In conclusion, in each embodiment of the present disclosure, a time-multiplexing control manner is used to use, in different intervals, a plurality of sensing electrodes of one of the electrode layers as electrodes for detecting a magnitude of a touch control force borne at a touch position and as common electrodes for providing a common voltage in a time-multiplexing manner. Therefore, one and the same electrode layer may have double functions, so that the overall thickness of a touch display panel can be effectively reduced, which is beneficial to thinning the touch display panel. In addition, because one and the same electrode layer may have double functions, the touch display panel can be provided with a function of detecting a magnitude of an external force without using an external pressure sensor, which can relatively reduce adhering procedures.

The foregoing are merely preferred embodiments of the present disclosure, and equivalent alternation and modification made according to the claims of the present disclosure are covered by the present disclosure.

What is claimed is:

1. A touch display panel, comprising:
a first electrode layer, comprising a plurality of first sensing electrodes;
a second electrode layer, comprising a plurality of second sensing electrodes;
a third electrode layer, comprising a plurality of third sensing electrodes;
a first dielectric layer, disposed between the first electrode layer and the second electrode layer;
a second dielectric layer, comprising a flexible material; and
an active layer;
wherein the touch display panel determines a touch position according to a first capacitance variation between the first sensing electrodes and the second sensing electrodes;
wherein, in a first interval, the touch display panel determines a touch pressure at the touch position according to a second capacitance variation between the third electrode layer and the active layer or the second electrode layer;
wherein, in a second interval, the touch display panel provides a common voltage to the third sensing electrodes for executing a display function; and
wherein the first interval and the second interval do not overlap each other in time sequence, and the common voltage is at a constant voltage level.

2. The touch display panel as claimed in claim 1, wherein the first sensing electrodes disposed in parallel along a first direction, the second sensing electrodes disposed in parallel along a second direction, the third sensing electrodes disposed in parallel along a third direction, the first direction and the second direction are not parallel to each other, and the second direction and the third direction are not parallel to each other.

3. The touch display panel as claimed in claim 2, further comprising an upper substrate and a lower substrate, wherein:
the active layer is formed on the lower substrate;
the first dielectric layer comprises a color filter layer, and the first electrode layer is formed between the upper substrate and the color filter layer; and
the second dielectric layer comprises a liquid crystal layer, and the third electrode layer is formed between the active layer and the second dielectric layer,
in the first interval, determines the touch pressure at the touch position.

4. The touch display panel as claimed in claim 2, wherein:
the first dielectric layer comprises an upper substrate, and the first electrode layer is formed on the upper substrate; and
the second dielectric layer comprises a color filter layer and a liquid crystal layer, and the third electrode layer is formed between the active layer and the second dielectric layer,
in the first interval, determines the touch pressure at the touch position.

5. The touch display panel as claimed in claim 2, wherein:
the first dielectric layer comprises an insulating layer;
the second electrode layer is formed on an upper substrate; and
the second dielectric layer comprises the upper substrate, a color filter layer and a liquid crystal layer, and the third electrode layer is formed between the active layer and the second dielectric layer,
wherein in the first interval, determines the touch pressure at the touch position.

6. The touch display panel as claimed in claim 1, wherein the first sensing electrodes are disposed in parallel along a first direction, the second sensing electrodes are disposed in parallel along a second direction, the third sensing electrodes are disposed in a matrix manner, and the first direction and the second direction are not parallel to each other.

7. The touch display panel as claimed in claim 6, wherein:
the first dielectric layer comprises an insulating layer;
the first electrode layer and the second electrode layer are formed between an upper substrate and a color filter layer; and
the second dielectric layer comprises a liquid crystal layer, the liquid crystal layer is disposed on the active layer, and the third electrode layer is disposed between the color filter layer and the liquid crystal layer.

8. The touch display panel as claimed in claim 6, wherein:
the first dielectric layer comprises an insulating layer;
the second electrode layer is formed on an upper substrate; and
the second dielectric layer comprises a liquid crystal layer, the third electrode layer is disposed between a color filter layer and the liquid crystal layer, and the liquid crystal layer is disposed on the active layer.

9. The touch display panel as claimed in claim 1, wherein in the first interval, the active layer is at a reference voltage, the touch display panel determines the second capacitance variation between the third sensing electrodes and the active layer in a self-capacitance manner by means of the third sensing electrodes, and further determines the touch pressure at the touch position.

10. A sensing and driving method for driving a touch display panel, wherein the touch display panel comprises:
a first electrode layer, comprising a plurality of first sensing electrodes;
a second electrode layer, comprising a plurality of second sensing electrodes;
a third electrode layer, comprising a plurality of third sensing electrodes;
a first dielectric layer, disposed between the first electrode layer and the second electrode layer; and
a second dielectric layer, comprising a flexible material; and
the sensing, and
the driving method comprises:
providing a first driving signal to the second sensing electrodes to detect a first touch position;
receiving a first sensing signal from the first sensing electrodes to detect the first touch position of the touch display panel, wherein a voltage level of the first sensing signal is related to a first capacitance variation between the first sensing electrodes and the second sensing electrodes;
in a first interval, receiving a second sensing signal, so as to determine a touch pressure at the first touch position; and
in a second interval, providing a common voltage to the third sensing electrodes, wherein the first interval and the second interval do not overlap each other in time sequence, and the common voltage has a constant voltage level provided for the touch display panel to execute a pixel driving function.

11. The sensing and driving method as claimed in claim 10, wherein the first driving signal is supplied to the second sensing electrodes in the first interval and the second interval, and the first sensing signal is received in the first interval and the second interval.

12. The sensing and driving method as claimed in claim 11, wherein the second sensing signal is received from the third electrode layer, and a voltage level of the second sensing signal is related to a second capacitance variation between the second sensing electrodes and the third sensing electrodes.

13. The sensing and driving method as claimed in claim 10, further comprising:
in a first sub-interval of the first interval, providing a second driving signal to the second sensing electrodes; and
in a second sub-interval of the first interval, receiving the second sensing signal generated by the second sensing electrodes in response to the second driving signal, wherein a voltage level of the second sensing signal is related to a second capacitance variation of the second electrode layer.

14. The sensing and driving method as claimed in claim 10, further comprising:
in a first sub-interval of the first interval, providing a second driving signal to the third sensing electrodes; and
in a second sub-interval of the first interval, receiving the second sensing signal generated by the third sensing electrodes in response to the second driving signal, wherein a voltage level of the second sensing signal is related to a second capacitance variation of the third electrode layer.

15. A sensing and driving method for driving a touch display panel, wherein the touch display panel comprises:
a first electrode layer, comprising a plurality of first sensing electrodes;
a second electrode layer, comprising a plurality of second sensing electrodes; and
a first dielectric layer, formed between the first electrode layer and the second electrode layer and comprising a flexible material; and
the sensing and driving method comprises:
in a first interval, providing a first driving signal to the second sensing electrodes, and receiving a first sensing signal from the first electrode layer, so as to detect a touch position of the touch display panel, wherein a voltage level of the first sensing signal is related to a first capacitance variation between the first sensing electrodes and the second sensing electrodes;
in a second interval, receiving a second sensing signal from the second sensing electrodes, so as to determine a touch pressure at the touch position; and
in a third interval, providing a common voltage to the second sensing electrodes, wherein the first interval, the second interval, and the third interval do not overlap to each other in time sequence, and the common voltage has a constant voltage level provided for the touch display panel to perform pixel driving.

16. The sensing and driving method as claimed in claim 15, further comprising:
in the second interval, providing a second driving signal to the first sensing electrodes, wherein the second sensing signal is generated in response to the second driving signal, and a voltage level of the second sensing signal is related to the first capacitance variation between the first sensing electrodes and the second sensing electrodes.

17. The sensing and driving method as claimed in claim 15, further comprising:
in the second interval, providing a second driving signal to the second sensing electrodes, and providing a reference voltage to the active layer, wherein a voltage level of the second sensing signal is related to a second capacitance variation between the second sensing electrodes and the active layer.

18. A sensing and driving method for driving the touch display panel according to claim 15, wherein the sensing and driving method comprises:
in a position detection frequency, providing a first driving signal to the second sensing electrodes, and receiving a first sensing signal from the first sensing electrodes, so as to detect a touch intensity of a touch event of the touch display panel ;
determining whether the touch intensity of the touch event is greater than a first predetermined touch intensity;
when the touch intensity of the touch event is greater than the first touch intensity, detecting the touch pressure in a pressure detection frequency, and detecting the touch event in the position detection frequency, wherein the pressure detection frequency is smaller than the position detection frequency;
determining whether the touch pressure is greater than a preset pressure; and
when the touch pressure is greater than the preset pressure, adjusting the position detection frequency or the pressure detection frequency so that the pressure detection frequency is greater than the position detection frequency.

19. The sensing and driving method as claimed in claim 18, further comprising:
determining whether the touch intensity of the touch event is greater than a second touch intensity, wherein the second touch intensity is greater than the first touch intensity; and
when the touch intensity of the touch event is greater than the second touch intensity, detecting the touch pressure of the touch display panel in an active area of the touch event.
